(19) United States
(12) Patent Application Publication
(10) Pub. No.: US 2019/0047367 A1
(43) Pub. Date: Feb. 14, 2019

(54) RADIANT HEATING SYSTEM FOR A MOTOR VEHICLE

(71) Applicant: FORD GLOBAL TECHNOLOGIES, LLC, Dearborn, MI (US)

(72) Inventors: John Craig Elson, Bloomfield Township, MI (US); Clay Wesley Maranville, Ypsilanti, MI (US); Kenneth Edward Nietering, Dearborn, MI (US); Richard H. Wykoff, II, Commerce Township, MI (US)

(73) Assignee: FORD GLOBAL TECHNOLOGIES, LLC, Dearborn, MI (US)

(21) Appl. No.: 15/675,327

(22) Filed: Aug. 11, 2017

(51) Int. Cl. B60H 1/22

(52) U.S. Cl. CPC B60H 1/2218; B32B 2311/16; B32B 17/10211; B32B 2307/416; B32B 2255/205; B32B 2307/30

(57) ABSTRACT

A radiant heating system is provided for a motor vehicle. That radiant heating system includes a first surface configured to reflect IR radiation toward a motor vehicle occupant and a first IR heating element oriented to direct IR radiation toward the first surface whereby the motor vehicle occupant is warmed indirectly by the IR radiation emitted from the first IR heating element.

### TECHNICAL FIELD

This document relates generally to the motor vehicle equipment field and, more particularly, to a radiant heating system that provides rapid and efficient radiant heat to warm occupants of a motor vehicle even when the motor vehicle has been sitting overnight in low temperature conditions.

### BACKGROUND

A standard automobile heating, ventilating and air conditioning (HVAC) system heats by circulating air through a heater core where that air is put in a heat exchange relationship with coolant circulated from the motor vehicle engine. After the motor vehicle has been at rest in low temperature conditions for an extended period of time, the engine coolant cools to the ambient temperature and requires a substantial amount of time before it warms sufficiently to provide heat to the air being circulated by the HVAC system. Further, the warmed air must first warm the ducts and blend with all the cold air in the passenger compartment of the motor vehicle before providing a significant warming sensation to the motor vehicle occupants. This delay can lead to occupant dissatisfaction.

Additionally it should be appreciated that inefficiencies, affecting fuel economy, are currently built into combustion engines to meet climate targets (e.g. spark retard). The warming of air in cold situations in electric vehicles requires using some of the travel range to heat the vehicle. Further, while a motor vehicle may be equipped with positive temperature coefficient (PTC) heaters which under many conditions will reach air warming temperatures prior to engine coolant, such heaters still require time to heat the air in the passenger compartment of the motor vehicle.

This document relates to a new and improved radiant heating system for a motor vehicle that addresses and solves these issues. Such a system quickly and efficiently transfers heat to an occupant by means of infrared radiation. Accordingly, a warming sensation is provided even while the air in the motor vehicle remains cold.

### SUMMARY

In accordance with the purposes and benefits described herein, a radiant heating system for a motor vehicle comprises a first surface configured to reflect infrared (IR) radiation toward a motor vehicle occupant and a first IR heating element oriented to direct IR radiation towards the first surface whereby said motor vehicle occupant is warmed indirectly by the IR radiation emitted from the first IR heating element.

The first surface may include an IR reflective layer. That IR reflective layer may be selected from a group consisting of an IR reflective coating, an IR reflective film and combinations thereof.

The first surface may be a windshield and the first IR heating element may be carried on an upper surface of a dashboard of the motor vehicle. In another possible embodiment, the first surface may be a rear window and the first IR heating element may be carried on a package tray behind the rear seat of the motor vehicle. In still another possible embodiment, the first surface may be a headliner and the IR heating element may be carried on a headrest of the motor vehicle. In still another possible embodiment, the first surface may be a side door window and the IR heating element may be carried on a headrest of the motor vehicle.

The radiant heating system may further include a second surface configured to reflect IR radiation toward the motor vehicle occupant and a second IR heating element oriented to direct IR radiation toward the second surface whereby the motor vehicle occupant is warmed indirectly by the IR radiation emitted from the second IR heating element. In one possible embodiment, the first surface may be a windshield, the second surface may be an inner roof structure liner, the first IR heating element may be carried on an upper surface of a dashboard and the second IR heating element may be carried on a headrest. In another possible embodiment, the first surface is a windshield, the second surface is a side door window, the first IR heating element is carried on an upper surface of a dashboard and the second IR heating element is carried on a headrest.

In still another possible embodiment, the second surface may be configured to reflect IR radiation toward a second motor vehicle occupant and a second IR heating element may be oriented to direct IR radiation toward the second surface whereby the second motor vehicle occupant is warmed indirectly by the IR radiation emitted from the second IR heating element. In such an embodiment, the first surface may be a windshield, the second surface may be a rear window, the first IR heating element may be carried on an upper surface of a dashboard and the second IR hearing element may be carried on a package tray behind the rear seat.

In another possible embodiment the first surface may be a headliner. The second surface may be a rear window, the first IR heating element may be carried on a headrest and the second IR heating element may be carried on a package tray. In yet another possible embodiment, the first surface may be a side door window, the second surface may be a rear window, the first IR heating element may be carried on a headrest and the second IR heating element may be carried on a package tray.

In still another possible embodiment, the radiant heating system further includes a third surface configured to reflect IR radiation toward a second motor vehicle occupant and a third IR heating element oriented to direct IR radiation toward the third surface whereby the second motor vehicle occupant is warmed indirectly by the IR radiation admitted from the third IR heating element. In such an embodiment the first surface may be a windshield, the second surface may be a headliner, the third surface may be a rear window, the first IR heating element may be carried on an upper surface of a dashboard, the second IR heating element may be carried on a headrest and the third IR heating element may be carried on a package tray.

In an alternative embodiment, the first surface may be a windshield, the second surface may be a side door window, the third surface may be a rear window and the first IR heating element may be carried on an upper surface of a dashboard while the second IR heating element is carried on a headrest and the third IR heating element is carried on a package tray. Further, the first surface, the second surface and the third surface may all include an IR reflective layer.

In accordance with yet another aspect, a radiant heating system for a motor vehicle comprises a first surface, a second surface and an IR heating element wherein the IR heating element is oriented to direct IR radiation toward the first surface, the first surface is oriented to reflect that IR radiation toward the second surface and the second surface is oriented to reflect IR radiation toward a motor vehicle occupant. In such an embodiment the first surface may include a first IR reflective layer and the second surface may include a second IR reflective layer. The first IR reflective layer and the second IR reflective layer may be selected from a group consisting of an IR reflective coating, an IR reflective film, an IR reflective material, such as silver, gold, copper and the like, and combinations thereof. In some embodiments, the second surface may be concave to concentrate the heating effect of the reflected IR radiation upon a smaller area. In other embodiments, the second surface may be convex to spread the IR radiation over a larger area. In one exemplary embodiment the first surface may be a rear window, the second surface may be a dedicated reflector pivotally attached to an inner roof structure of the motor vehicle and the IR heating element may be carried on a package tray.

In the following description, there are shown and described several preferred embodiments of the radiant heating system. As it should be realized, the radiant heating system is capable of other, different embodiments and its several details are capable of modification in various, obvious aspects all without departing from the radiant heating system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the radiant heating system and together with the description serve to explain certain principles thereof. In the drawing figures:

FIG. 1 is a schematic side elevational view of a first possible embodiment of radiant heating system.

FIG. 2 is a schematic side elevational view of a second possible embodiment of radiant heating system.

FIG. 3 is a schematic side elevational view of a third possible embodiment of radiating heating system for a motor vehicle.

FIG. 4 is a schematic side elevational view of a fourth possible embodiment of radiant heating system for a motor vehicle.

FIG. 5 is a schematic side elevational view of a fifth possible embodiment of radiant heating system for a motor vehicle.

FIG. 6 is a schematic front elevational view of a sixth possible embodiment of radiant heating system for a motor vehicle.

FIG. 7 is a schematic side elevational view of a seventh possible embodiment of radiant heating system for a motor vehicle.

Reference will now be made in detail to the present preferred embodiments of the radiant heating system, examples of which are illustrated in the accompanying drawing figures.

### DETAILED DESCRIPTION

Reference is now made to the drawing figures illustrating a plurality of embodiments of a radiant heating system 10 for a motor vehicle. Advantageously, any of the embodiments of the radiant heating system 10 are capable of providing fast time constant heating of a motor vehicle occupant O by means of infrared radiation reflected from various specular surfaces adapted to reflect IR energy toward the occupant.

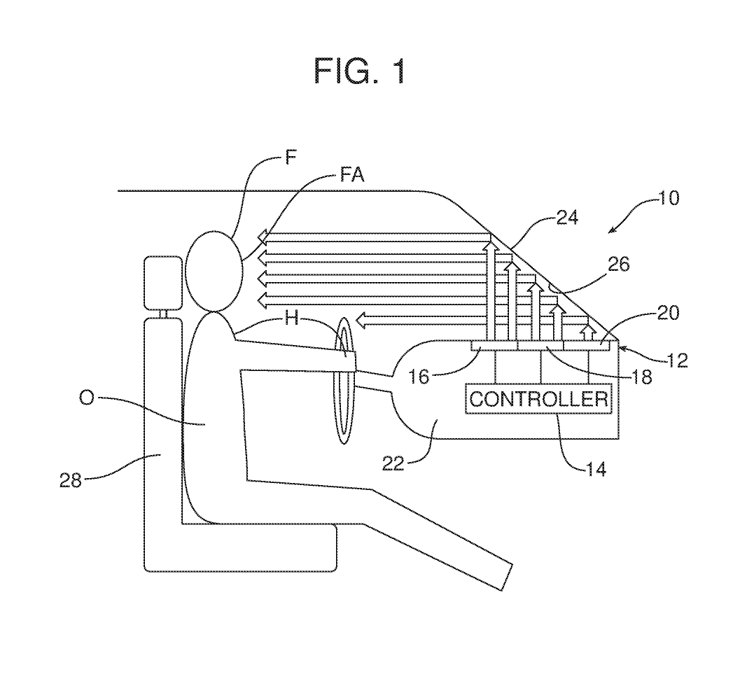

FIG. 1 illustrates a first possible embodiment of radiant heating system 10. The radiant heating system 10 of FIG. 1 includes a first IR heating element 12 connected to a controller 14. Controller 14 may comprise a computing device such as a dedicated microprocessor or an electronic control unit (ECU) operating in accordance with instructions from appropriate control software. Thus, the controller 14 may comprise one or more processors, one or more memories and one or more network interfaces all in communication with each other over a communicator bus.

In the illustrated embodiment the IR heating element 12 comprises a first section 16, a second section 18 and a third section 20 wherein the intensity of each section may be varied by the controller 14 automatically in accordance with an appropriate control algorithm or predetermined settings input by the operator. As illustrated, the IR heating element 12 is carried on the upper face of the dashboard 22 and oriented toward the windshield 24. The windshield 24 includes a first surface 26 configured to reflect IR radiation emitted from the IR heating element 12 toward the windshield 24 toward the motor vehicle occupant O seated in the driver's seat 28. Note the action arrows representing the path followed by the IR radiation.

Toward this end, the first surface 26 is an infrared specular surface adapted to reflect IR energy. Thus, the first surface 26 may include an IR reflective layer. That IR reflective layer may be selected from a group consisting of an IR reflective coating, an IR reflective film, an IR reflective material, such as silver, gold, copper and the like, and combinations thereof. As should be appreciated, the radiant heating system 10 illustrated in FIG. 1 functions to indirectly warm the motor vehicle occupant O by IR radiation emitted from the first IR heating element 12 and reflected from the first surface 26 of the windshield 24.

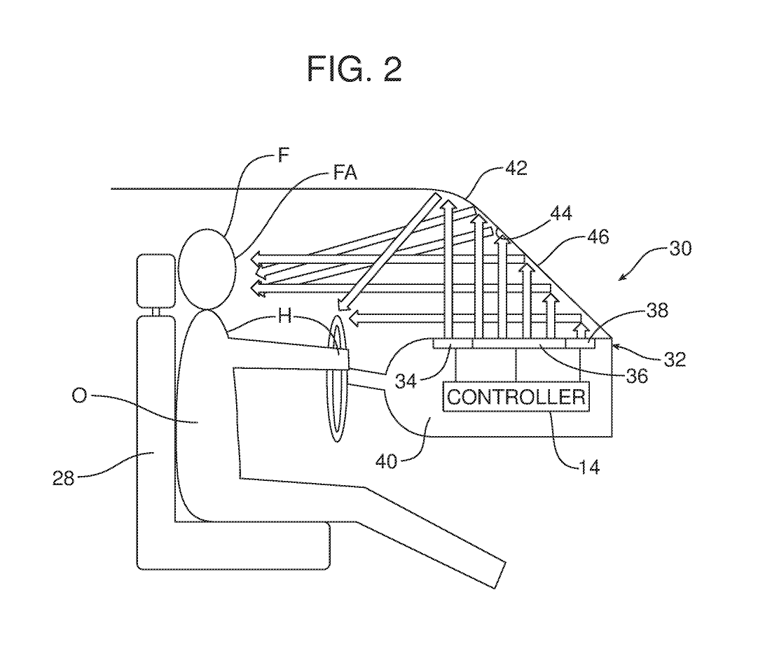

Reference is now made to FIG. 2 illustrating an alternative embodiment of radiant heating system 30 which also includes an IR heating element 32 including a first section 34, a second section 36 and a third section 38 mounted in the upper surface of the dashboard 40.

In the FIG. 1 embodiment, the first surface 26 of the windshield 24 is substantially planar thereby reflecting IR radiation emitted in a vertical direction from the IR heating element 12 toward the windshield 24 horizontally toward the occupant. In contrast, in the FIG. 2 embodiment, the upper portion 42 of the first surface 44 of the windshield 46 is curved so as to form a concavity. As a result, IR radiation emitted from the IR heating element 32 is reflected by the first surface 44 as illustrated by the action arrows.

Significantly, in the first embodiment of the radiant heating system 10 illustrated in FIG. 1, IR radiation emitted from the first section 16 of the IR heating element 12 is directed toward the forehead F of the motor vehicle occupant while IR radiation emitted from the second section 18 of the heating element is directed toward the face FA of the occupant and IR radiation emitted from the third section 20 of the IR heating element is reflected toward the hands/upper torso H of the occupant. In contrast, in the FIG. 2 embodiment of the radiant heating system 30, IR radiation from the first section 34 and third section 38 of the IR heating element 32 is reflected toward the hands/upper body H of the motor vehicle occupant O while IR radiation from the second section 36 of the IR heating element 32 is reflected toward the face FA and forehead F of the occupant O.

As should be appreciated, the controller 14 may adjust the intensity of each section 16, 18, 20 or 34, 36, 38 of the respective IR heating elements 12, 32 to maximize the comfort level of the motor vehicle occupant O across each heating zone (i.e. forehead F, face FA, and hands/upper torso H). In some embodiments the controller 14 may be pre-programmed with customized settings for each motor vehicle occupant O. Each embodiment of the radiant heating system 10, 30 may also allow for manual adjustment of the various sections 16, 18, 20 or 34, 36, 38 of the IR heating element 12, 32 as desired.

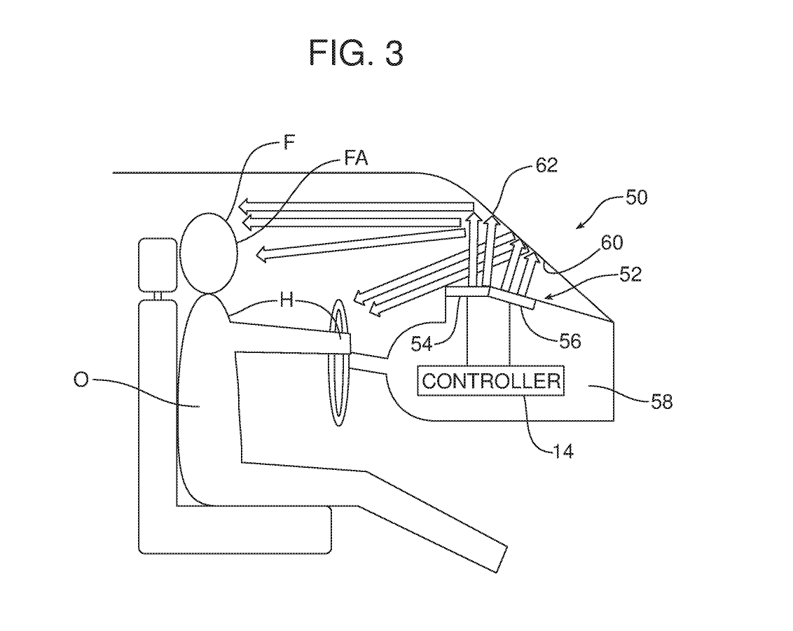

FIG. 3 illustrates yet another possible embodiment of radiant heating system 50 including an IR heating element 52 having a first section 54 and a second section 56. The IR heating element 52 is again mounted at the top of the dashboard 58. As illustrated, due to the angular orientation of the first section 54 and second section 56 of the IR heating element 52 with respect to the first or specular surface 60 of the windshield 62, IR radiation emitted from the first section 54 is reflected toward the forehead F and face FA of the motor vehicle occupant O while the IR radiation emitted from the second section 56 of the IR heating element 52 is reflected toward the hands/upper torso H of the motor vehicle occupant.

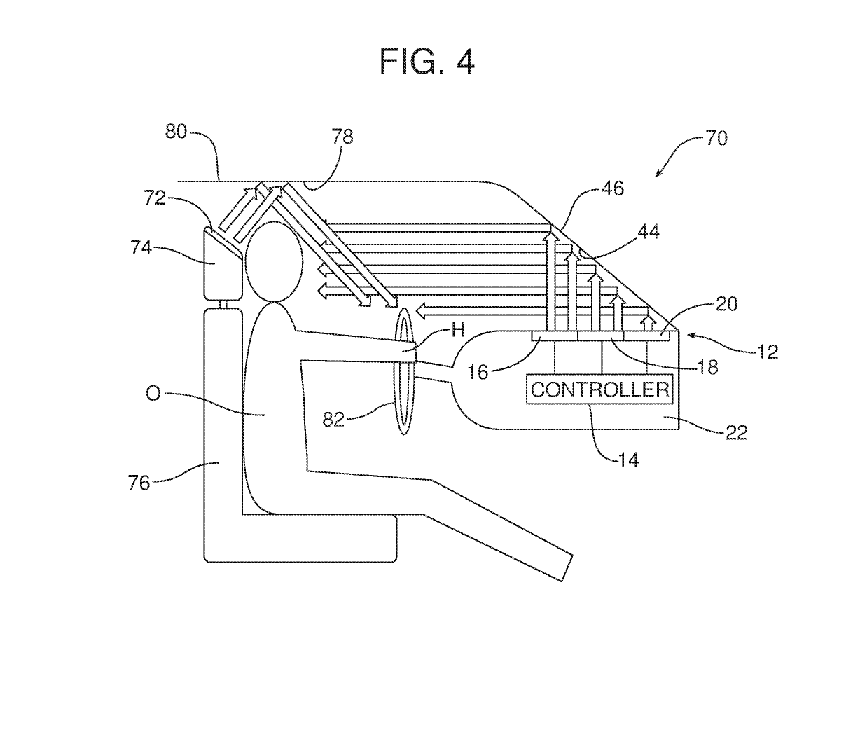

Reference is now made to FIG. 4 illustrating yet another possible embodiment of radiant heating system 70. This embodiment of radiant heating system 70 includes an IR heating element 12 with three sections 16, 18, 20 in the upper surface in the dashboard 22 just as illustrated in FIG. 1. In addition, the radiant heating system 70 includes a second IR heating element 72 carried on the headrest 74 of the car seat 76. IR radiation emitted from the second IR heating element 72 is directed toward a second surface 78 provided on the headliner 80. The second surface 78 is an infrared specular surface adapted to reflect IR energy toward the hands H of the occupant O positioned on the steering wheel 82.

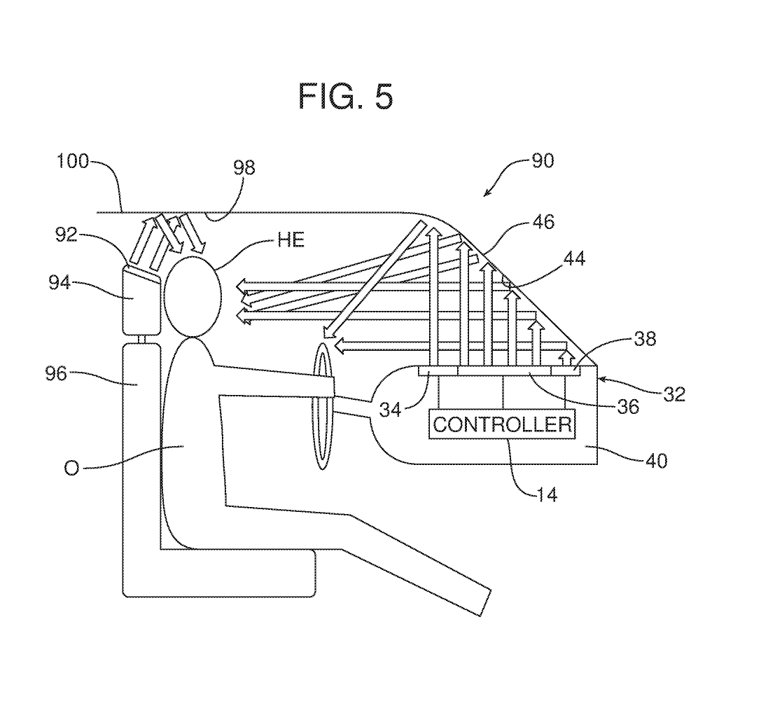

FIG. 5 illustrates yet another possible embodiment wherein the radiant heating system 90 includes an IR heating element 32 with three sections 34, 36, 38 in the upper face of the dashboard 40 for directing IR radiation off a first or specular surface 44 of the windshield 46 just as illustrated in the FIG. 2 embodiment. In addition, the radiant heating system 90 includes a second IR heating element 92 carried on the headrest 94 of the motor vehicle seat 96 and adapted to emit IR radiation toward a second surface 98 on the headliner or roof glass 100. The second surface 98 comprises an infrared specular surface adapted to reflect the IR energy emitted from the second IR heating element 92 toward the top of the head HE of the motor vehicle occupant O.

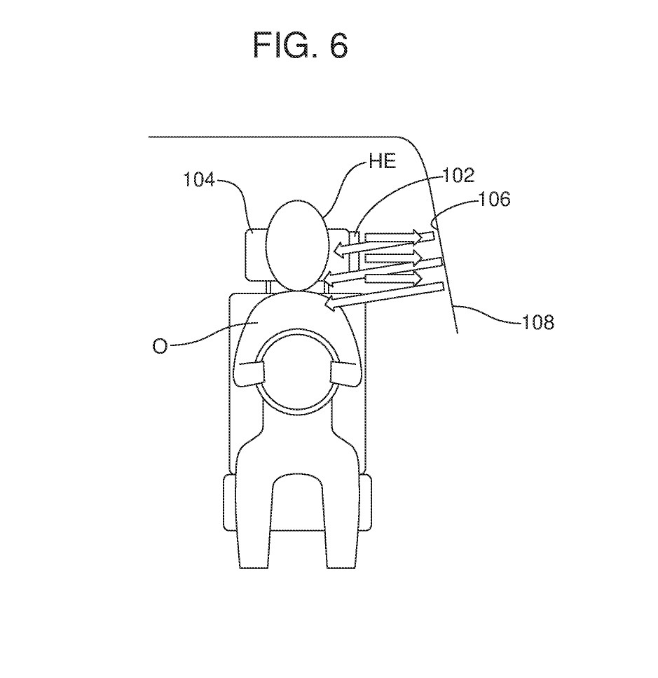

Either of the embodiments of the radiant heating system 70, 90 illustrated in FIGS. 4 and 5 may include a third IR heating element 102. As illustrated in FIG. 6, the third IR heating element 102 is provided on the side of the headrest 104. IR radiation emitted from the third IR heating element 102 is directed toward a third specular surface 106 of a side door window 108. The third surface 106 is an infrared specular surface adapted to reflect the IR radiation from the third IR heating element 102 back toward the head and neck HE of the motor vehicle occupant O.

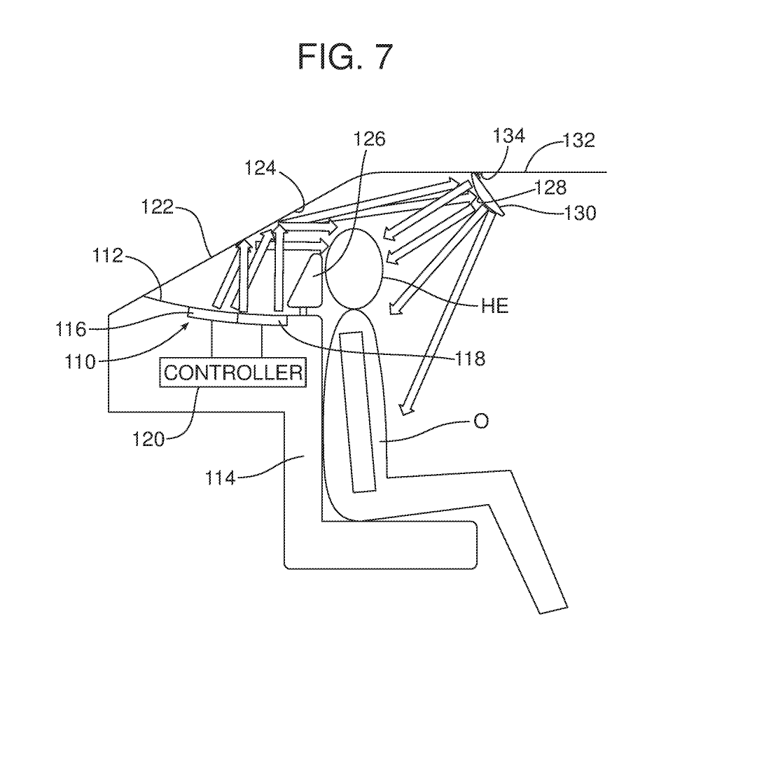

As illustrated in FIG. 7, a third IR heating element 110 is carried on the package tray 112 behind the rear seat 114 and the occupant O. In the illustrated embodiment, the third IR heating element 110 comprises a first section 116 and a second section 118 connected to a controller 120 providing individual intensity control for each section. As illustrated, IR radiation emitted by the first section 116 and second section 118 of the third IR heating element 110 is directed upward from the package tray 112 toward the rear window 122. Rear window 122 includes a third surface 124 that is configured as an infrared specular surface to reflect IR energy with a portion of that energy being directed over the headrest 126 to the back of the head HE of the occupant O while a second portion of that IR energy is reflected toward a fourth surface 128.

In the illustrated embodiment, the fourth surface 128 is an infrared specular surface of a dedicated reflector 130 that is pivotally mounted to the inner roof structure 132 of the motor vehicle by a pivot 134 thereby making it angularly adjustable to direct the IR radiation toward the occupant O at any desired location. As illustrated in FIG. 7, the second surface 128 is convex thereby spreading the radiation outwardly as it is reflected from the surface toward the motor vehicle occupant.

The various embodiments of the radiant heating systems 10, 30, 50, 70 and 90 illustrated in the drawing figures are just a few limited examples of a nearly infinite possible combination of IR heating elements 12, 32, 52, 72, 92, 102, 110. Thus it should be appreciated that the radiant heating systems 10, 30, 50, 70, 90 illustrated in the drawing figures are not limiting in scope and substantially any combination of IR heating elements 12, 32, 52, 72, 92, 102, 110 may be provided to rapidly and efficiently warm occupants of the motor vehicle sitting in the driver's seat, the front passenger seat or anywhere in the rear seat area.

Similarly, it should be appreciated that the IR heating elements 12, 32, 52, 72, 92, 102, 110 and the cooperating specular surfaces 26, 44, 60, 78, 98, 106, 124, 128 for reflecting the IR energy from the heating elements toward the occupants O are angularly arranged to provide the desired indirect heating of the occupants while simultaneously maintaining the best possible sight lines from the motor vehicle and locating IR heating elements out of reach range of those occupants if desired.

Any of the IR heating elements 12, 32, 52, 72, 92, 102, 110 may include a decorative outer surface layer made from an IR transparent medium. Further, the IR heating elements 12, 32, 52, 72, 92, 102, 110 may be mounted in or on the headrest 74, 94 or 104 and dashboard 22, 40 or 58 or package tray 112 utilizing insulating medium with a low thermal conductivity.

All specular surfaces 26, 44, 60, 78, 98, 106, 124, 128 in the mid to long IR spectrum could include but are not limited to platinum, gold, silver, copper, aluminum, stainless steel and titanium dioxide. They may have a polished or matte finish. The surfaces 26, 44, 60, 78, 98, 106, 124, 128 may be flat, convex or concave with the ability to focus or disperse IR energy. Other irregular or combined convex and concave surfaces may be utilized depending upon the particular application.

The surfaces may also be visibly transparent such as, for example, when the surface is on a windshield 24, 42 or 62, side door window 108 or rear window 122, diffuse or visibly opaque.

There are a number of coating systems that may be utilized on the windshield 24, 42 or 62, side door window 108 and rear window 122 that offer high visible transmittance and high reflectivity in the mid-infrared portion of the electromagnetic spectrum. These include doped metal oxides such as tin-doped indium oxide (ITO), fluorine-doped tin oxide as well as more sophisticated ITO coatings sandwiched between layers of oxides, nitrides and oxy-nitrides to enhance chemical and mechanical durability. Coatings of this type are available from Saint-Gobain Sekurit and other sources.

Additional IR reflective coatings based on silver are also available. An example of such a silver-based coating is disclosed in U.S. Pat. No. 6,445,503.

The specular third surface 124 of the dedicated reflector 130 illustrated in FIG. 7 may be covered with a medium transparent to the IR spectrum for styling and to protect the surface. Such materials include (1) inorganics such as silicone sheet, silicone aerogel, germanium, zinc selenium, zinc sulfide and potassium bromide as well as (2) low IR absorptivity materials on the side toward the radiant panel mesh screen.

As should be apparent, each IR heating element 12, 32, 52, 72, 92, 102, 110 may include one or more sections 16, 18, 20 or even one or more independent heating elements with the intensity of the IR radiation being controlled by the controller 14 through manipulation of the drive power to each section or heating element and/or controlling the number of heating elements. The IR heating elements 12, 32, 52, 72, 92, 102, 110 may be adjustably mounted and manually or mechanically actuated to aim at different locations so as to provide heating to a desired location.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A radiant heating system for a motor vehicle, comprising:
a first surface configured to reflect IR radiation toward a motor vehicle occupant; and
a first IR heating element oriented to direct IR radiation toward said first surface whereby said motor vehicle occupant is warmed indirectly by said IR radiation emitted from said first IR heating element.

2. The radiant heating system of claim 1, wherein said first surface includes an IR reflective layer.

3. The radiant heating system of claim 2, wherein said IR reflective layer is selected from a group consisting of an IR reflective coating, an IR reflective film, IR reflective material and combinations thereof.

4. The radiant heating system of claim 2, wherein said first surface is a windshield and said first IR heating element is carried on an upper face of a dashboard of said motor vehicle.

5. The radiant heating system of claim 2, wherein said first surface is a rear window and said first IR heating element is carried on a package tray of said motor vehicle.

6. The radiant heating system of claim 2, wherein said first surface is a headliner or roof glass and said IR heating element is carried on a headrest of said motor vehicle.

7. The radiant heating system of claim 2, wherein said first surface is a side door window and said IR heating element is carried on a headrest of said motor vehicle.

8. The radiant heating system of claim 1, further including a second surface configured to reflect IR radiation toward said motor vehicle occupant and a second IR heating element oriented to direct IR radiation toward said second surface whereby said motor vehicle occupant is warmed indirectly by said IR radiation emitted from said second IR heating element.

9. The radiant heating system of claim 8, wherein said first surface is a windshield, said second surface is an inner roof structure liner, roof structure, roof glass, or combinations thereof, said first IR heating element is carried on an upper surface of a dashboard and said second IR heating element is carried on a headrest.

10. The radiant heating system of claim 8, wherein said first surface is a windshield, said second surface is a side door window, said first IR heating element is carried on an upper surface of a dashboard and said second IR heating element is carried on a headrest.

11. The radiant heating system of claim 1, further including a second surface configured to reflect IR radiation toward a second motor vehicle occupant and a second IR heating element oriented to direct IR radiation toward said second surface whereby said second motor vehicle occupant is warmed indirectly by said IR radiation emitted from said second IR heating element.

12. The radiant heating system of claim 11, wherein said first surface is a windshield, said second surface is a rear window, said first IR heating element is carried on an upper surface of a dashboard and said second IR heating element is carried on a package tray.

13. The radiant heating system of claim 11, wherein said first surface is a headliner, said second surface is a rear window, said first IR heating element is carried on a headrest and said second IR heating element is carried on a package tray.

14. The radiant heating system of claim 11, wherein said first surface is a side door window, said second surface is a rear window, said first IR heating element is carried on a headrest and said second IR heating element is carried on a package tray.

15. The radiant heating system of claim 11, further including a third surface configured to reflect IR radiation toward a second motor vehicle occupant and a third IR heating element oriented to direct IR radiation toward said third surface whereby said second motor vehicle occupant is warmed indirectly by said IR radiation emitted from said third IR heating element.

16. The radiant heating system of claim 15, wherein said first surface is a windshield, said second surface is a headliner, said third surface is a rear window, said first IR heating element is carried on an upper surface of the dashboard, said second IR heating element is carried on a headrest and said third IR heating element is carried on a package tray.

17. The radiant heating system of claim 15, wherein said first surface is a windshield, said second surface is a side door window, said third surface is a rear window, said first IR heating element is carried on an upper surface of the dashboard, said second IR heating element is carried on a headrest and said third IR heating element is carried on a package tray.

18. The radiant heating system of claim 15, wherein said first surface, said second surface and said third surface all include an IR reflective layer.

19. A radiant heating system for a motor vehicle, comprising:
a first surface;
a second surface; and
an IR heating element wherein said IR heating element is oriented to direct IR radiation toward said first surface, said first surface is oriented to reflect said IR radiation toward said second surface and said second surface is oriented to reflect said IR radiation toward a motor vehicle occupant.

20. The radiant heating system of claim 19, wherein said first surface is a rear window, said second surface is a dedicated reflector pivotally, translationally, or a combination thereof, attached to an inner roof structure and said IR heating element is carried on a package tray.
